(19) United States
(12) Patent Application Publication
(10) Pub. No.: US 2022/0174864 A1
(43) Pub. Date: Jun. 9, 2022

(54) Dual-Dexterous, Stem-Clipping and Harvesting Tool

(71) Applicants: Christopher M. Toner, Germantown, MD (US); Leighton W. Rice, Gettysburg, PA (US)

(72) Inventors: Christopher M. Toner, Germantown, MD (US); Leighton W. Rice, Gettysburg, PA (US)

(21) Appl. No.: 17/456,984

(22) Filed: Nov. 30, 2021

Related U.S. Application Data
(60) Provisional application No. 63/199,081, filed on Dec. 5, 2020.

(51) Int. Cl. A01D 1/14; A01D 1/06

(52) U.S. Cl. CPC A01D 1/14; A01D 1/06

(57) ABSTRACT

This invention is a mechanical harvesting device which uses a novel approach to cut stems on agricultural products such as apples. The device is comprised of a system including levers and a unique cutting blade profile which allows for directional transfer of force from the wrists and forearms to effectuate cutting. The device is designed so that the cutting of stems on agricultural products can be performed separately and autonomously by both arms, thus offering improvements in efficiency and safety over other harvesting practices where the cutting is performed using both hands together. Current improvements include revisions to the product interface and safety guide as well as new versions of the device, employing many of the same design elements but having as the main difference a powered motor to actuate the cutting sequence in place of levers. Future improvements include options for data generation using electronic signal processing to tabulate periodic count totals on harvested product. Such data would help growers and marketers gather valuable information about crop sizing and labor efficiency.

### FIELD OF THE INVENTION

Embodiments described herein generally relate to the harvesting of agricultural products. The primary action of harvesting many agricultural products could be described as the severing of a stem. Where that is done manually, it is often done with a twisting, pulling or rolling action. But in many cases it is done with a hand-held cutting tool such as a pair of secateurs. This type of harvesting presents challenges for efficiency and safety. With the right tool, a worker might be able to harvest agricultural products with both hands working on separate targets and staying clear of the cutting blade(s). Currently, in many cases, workers must perform the same job with both hands working on the same target which slows them down and presents possible safety risks.

### BACKGROUND OF THE INVENTION

Damages caused when the stem of an agricultural product or other attachment from the host plant pierces another product (hereby called stem punctures) are very common in the apple industry. Stem punctures happen when the apples come into direct contact with other apples in harvesting containers and bulk storage containers. When an apple is punctured, it loses all value in the fresh market and must be sold in processing markets. If an apple is thus downgraded by way of sorting in fresh market channels, the result is little or no profit for the grower. Additionally, to the direct damages from stem punctures are secondary damages caused to other apples in storage because of increased pressure from various rots and molds. All of these economic losses are shared downstream to packers, marketers and retailers when fresh products are rejected or otherwise abandoned in the marketplace.

The only way to prevent stem punctures in apples is to pull the stem out of the apple or to trim the stem below the shoulders of the apple so that it cannot reach the surface of other apples to cause damage. This must be done at the time of harvest to avoid damage downstream. Trimming the stem is preferred because it leaves no open scar for fungal pathogens to invade and also because consumers generally prefer apples that have stems.

According to the USDA Noncitrus Fruits and Nuts 2020 Summary, the average value of the total fresh market product for those years is about $0.38 per pound and for processing it is around $0.10 per pound, a reduction in value of $0.28 per pound from fresh to processing. The level of damage from punctures in an apple crop is dependent on many factors such as size and shape of stem as well as maturity of the fruit at the time of harvest, but it is often as high as 6% of the total volume. The 2020 National fresh apple crop came in at 170,870,000 bushels according to the same survey from USDA. Assuming a normalized reduction from losses not related to punctures (4% figure in place of the higher estimate of 6%), and not counting secondary losses, the total loss in value from stem punctures in 2020 was than $75 million dollars in 2020.

Apple growers around the world have accepted these losses as an uncontrolled cost because there have been no special methods or tools at harvest to remove stems except for the use of hand-clippers. As mentioned in paragraph 1, the use of hand-clippers slows the pickers down to a level that is beyond an economic threshold for control on most varieties because it severely limits the use of one of their hands for actions related to picking. A 2014 study by Penn State Extension showed that the average picker, working by the hour, goes from picking fifteen bushels per hour down to around ten bushels per hour when clipping stems. That reduction translates to a 33% loss in efficiency and as much as 50% increase in picking costs per bushel. Quite simply, cutting apple stems with hand-clippers is too expensive in most cases. There must be a better way.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary top-down view of a hands-free, dual-dexterous apple stem-clipping and harvesting tool configured to operate according to an embodiment of the present disclosure.

FIG. 2 shows an exemplary front view of a hands-free, dual-dexterous apple stem-clipping and harvesting system configured to operate in an embodiment of the present disclosure.

FIG. 3 shows an exemplary right-side view of a hands-free, dual-dexterous apple stem-clipping and harvesting system configured to operate in an embodiment of the present disclosure.

FIG. 4 shows an exemplary left-side view of a hands-free, dual-dexterous apple stem-clipping and harvesting system configured to operate in an embodiment of the present disclosure, referenced numbers suppressed for clarity.

FIG. 5 shows an exemplary bottom view of a hands-free, dual-dexterous apple stem-clipping and harvesting system configured to operate in an embodiment of the present disclosure, referenced numbers suppressed for clarity.

FIG. 6 shows an exemplary back view of a hands-free, dual-dexterous apple stem-clipping and harvesting system configured to operate in an embodiment of the present disclosure, referenced numbers suppressed for clarity.

FIG. 7 shows an exemplary front view of a hands-free, dual-dexterous apple stem-clipping and harvesting system detailing the open target area of the blades.

FIG. 8 shows an exemplary front view of a hands-free, dual-dexterous apple stem-clipping and harvesting system detailing closed position of the blades with the applied force vectors of this mode.

FIG. 9 shows an exemplary isometric view of a hands-free, dual-dexterous apple stem-clipping and harvesting system detailing the force transfer from the lever arms to the bearing guides to transfer chuck to the cutting blades.

FIG. 10 shows an exemplary front view of a hands-free, dual-dexterous apple stem-clipping and harvesting system detailing the resultant forces applied to the blade profile(s).

FIG. 11 shows exemplary front views of a hands-free, dual-dexterous apple stem-clipping and harvesting system detailing the product position to the cutting blade profile(s) and also the resultant stem cut profile.

FIG. 12 shows an exemplary front isometric view of a hands-free, dual-dexterous apple stem-clipping and harvesting system in the embodiment of attachment to a bag clip and having adjustable torso supports.

FIG. 13 shows an exemplary back isometric view of a hands-free, dual-dexterous apple stem-clipping and harvesting system in the embodiment of attachment to a bag clip and having adjustable torso supports.

FIG. 14 shows an exemplary front isometric view of a hands-free, dual-dexterous apple stem-clipping and harvesting system in the embodiment of attachment to a bag clip and harvest bag and having adjustable torso supports.

FIG. 15 shows an exemplary back isometric view of a hands-free, dual-dexterous apple stem-clipping and harvesting system in the embodiment of attachment to a bag clip and harvest bag and having adjustable torso supports.

FIG. 16 shows three exemplary front isometric views of a hands-free, dual-dexterous apple stem-clipping and harvesting system demonstrating pre-positioning of field-harvested product, stem-clipping of harvested product, and transfer of stem-clipped, harvested product to harvest bag.

FIG. 17 shows an exemplary front isometric view of a hands-free, dual-dexterous apple stem-clipping and harvesting system in the embodiment of attachment to a torso-worn interface brace and having adjustable torso supports.

FIG. 18 shows three exemplary front isometric views of a hands-free, dual-dexterous apple stem-clipping and harvesting system demonstrating pre-positioning of field-harvested product, stem-clipping of harvested product, and transfer of stem-clipped, harvested product to harvest bag, using the alternate embodiment of the torso-worn mount variant.

### SUMMARY OF THE INVENTION

Exemplary embodiments disclosed herein describe a harvest tool which has the potential to make certain types of harvesting practices more efficient and safer: more efficient by making it possible to perform the actions of picking and stem-clipping with only one hand, thus freeing up the second hand for other actions related to harvesting; safer by changing the action and mode of cutting to something which is less likely to cause accidental injury.

The harvest system includes dual-dexterous lever components which are actuated manually to transfer the direction of the force to a set of cutting blades that come together to effectuate severing of a stem. In certain embodiments the device can be mounted on a bag or container so that the agricultural products are easily transferred into bulk formations as part of the normal harvesting process. In this way are superseded and controlled most of the risk factors for damage between products, as caused by excessive stem length.

In other embodiments the same cutting mechanism can be mounted to a torso worn belt/vest or chest harness, adding further flexibility of use cases.

### DETAILED DESCRIPTION

Although some of the exemplary embodiments described herein are tailored to apples and the apple orchard environment, the present disclosed systems and methods are not limited to use in apples and can be used for other agricultural products such as oranges, mandarins, lemons, grapefruits, kiwis, persimmons, grapes, flowers, cannabis, and hemp.

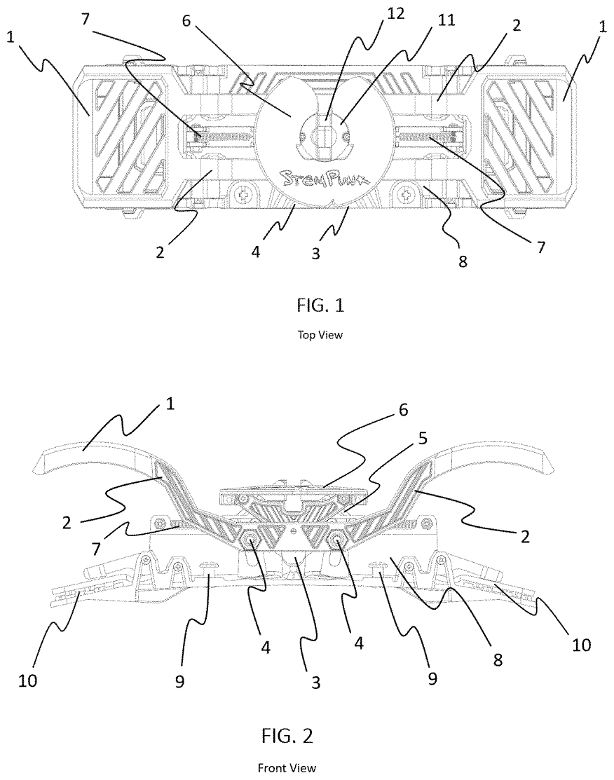

FIG. 1 is an exemplary top view of a hands-free, dual-dexterous stem-clipping and harvesting tool (“clipping device”). The system includes wrist force pads 1, lever arms 2 which have an arc radius of travel 4 around a dual-pivot axis point 3, and are connected by retraction springs 7. Additionally, FIG. 1 features a product interface and safety guide 6 surrounding opposing cutting blade profiles 11 in the prone position showing the open target area 12. The entire system is built upon a single attachment interface brace 8.

FIG. 2 is an exemplary front view of a hands-free, dual-dexterous clipping device in which the force transfer chuck for the cutting blades 5 is evident. The attachment interface brace 8 from FIG. 1 is also evident with attachment interface points 9, and lever arm force support and attachment interface points 10. Additional views for the wrist force pads 1, lever arms 2 with connecting retraction springs 7, arc radius of travel 4, dual pivot axis point 3, and product interface and safety guide 6 are also shown in FIG. 2.

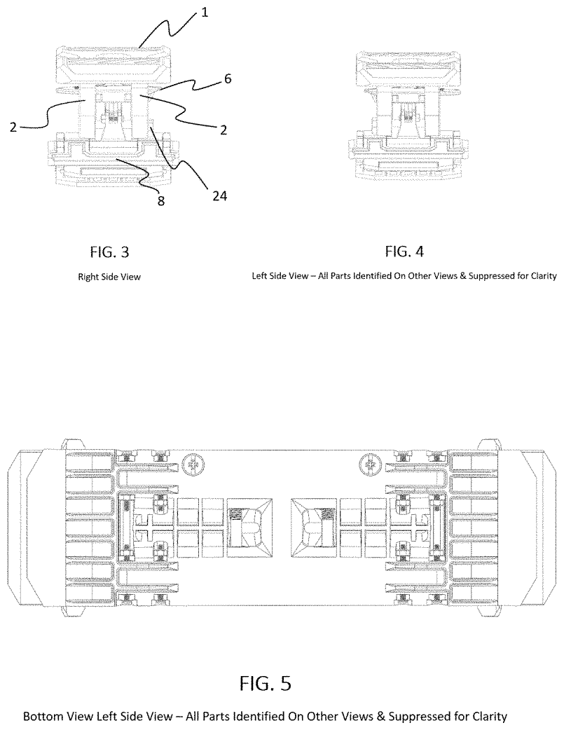

FIG. 3 is an exemplary right side view of a hands-free, dual-dexterous clipping device showing several locations for miscellaneous hardware and fasteners 24. FIG. 3 also shows additional views of the wrist force pads 1, lever arms 2, product interface and safety guide 6, and attachment interface brace 8.

FIG. 4 is an exemplary left side view of a hands-free, dual-dexterous clipping device. It is an opposing view to FIG. 3 revealing no distinct parts or potentials not already disclosed and detailed herein.

FIG. 5 is an exemplary bottom view of a hands-free, dual-dexterous clipping device. It is an opposing view to FIG. 1 revealing no distinct parts or potentials not already disclosed and detailed herein.

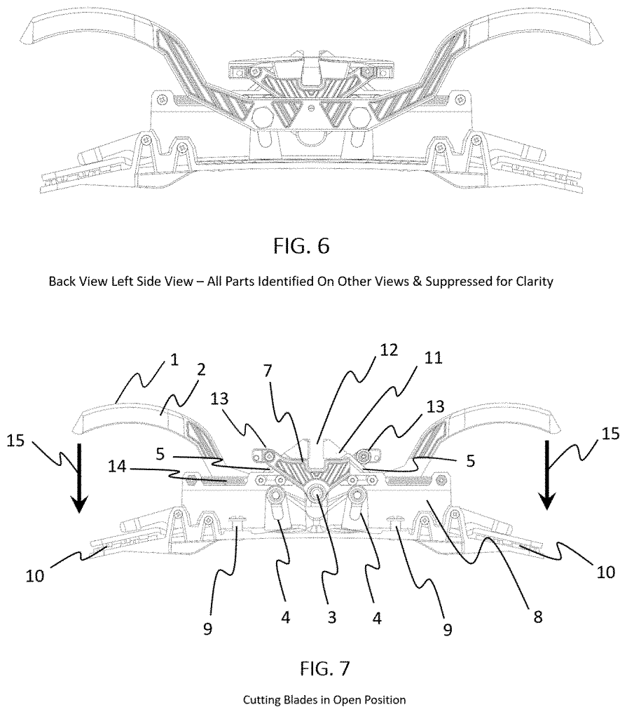

FIG. 6 is an exemplary back view of a hands-free, dual-dexterous clipping device. It is an opposing view to FIG. 2 revealing no distinct parts or potentials not already disclosed and detailed herein.

FIG. 7 is an exemplary front view of a hands-free, dual-dexterous clipping device with cutting blades in the open position. Absent in this view are the product interface and safety guide 6, evident in all previous figures, as well as the front-facing set of opposing lever arms 2 and retraction springs 7. With these parts removed, there is visibility of the bearing guides 13, expansion spring 14, and the applied force vector 15 as exemplified with directional arrows. All other numbered parts in FIG. 7 appear without views or potentials not already disclosed and detailed herein.

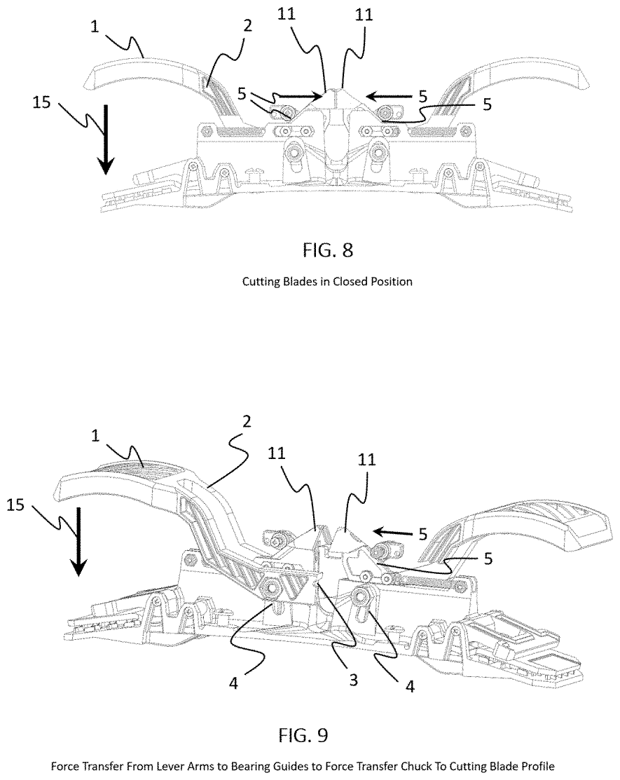

FIG. 8 is an exemplary front view of a hands-free, dual-dexterous clipping device with cutting blades in the closed position. In this view, more of the cutting blade profile(s) 11 are visible than in previous figures.

FIG. 9 is an exemplary isometric, front view of a hands-free, dual-dexterous clipping device. Absent in this view are one half of one set of lever arms 2 and miscellaneous hardware 24. This particular view gives more visibility to the force transfer from the lever arms 2 to the bearing guides 13 to transfer chuck 5 to the cutting blades 11. The isometric view also gives better visibility of the contour of the cutting blade profile(s) 11.

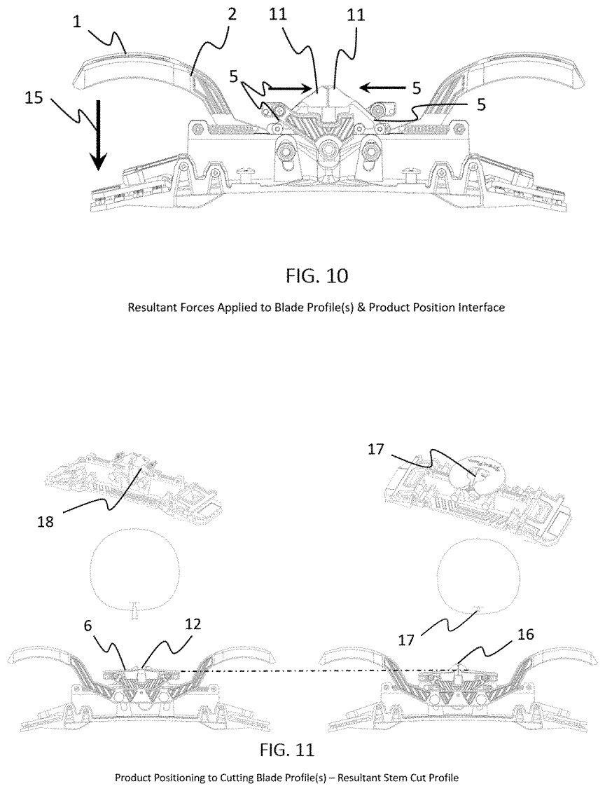

FIG. 10 is another exemplary front view of a hands-free, dual-dexterous clipping device. The product interface and safety guide 6 along with one set of opposing lever arms 2 and retraction springs 7 are have been suppressed for clarity 6. With the applied force vector 15 in the depressed position, the force transfer chuck(s) 5 are drawn together, leading the cutting blades to make contact and effectuate cutting.

FIG. 11 shows four separate views of the stem-clipping device. The first view at top left is an isometric front view with all parts absent except the attachment interface brace 8, the force transfer chuck 5, the cutting blade profile(s) 11, and the bearing guides 13. Thus positioned and with parts removed, there is visibility of the force transfer chuck path guide 18. The second view at top right shows an isometric top view with all parts absent except the attachment interface brace 8, the force transfer chuck (5), the product interface and safety guide 6, and the cutting blade profile(s) 11. Thus positioned and with parts removed, there is visibility of the stem-clipping cut profile 17. The third view at bottom left is a front view illustrating product positioning with respect to the product interface and safety guide 6 and open target area 12. The fourth view is the same as the third view but shows the device in the closed position, illustrating the product stem-clipping height profile 16 and the resulting product stem-clipping cut profile 17.

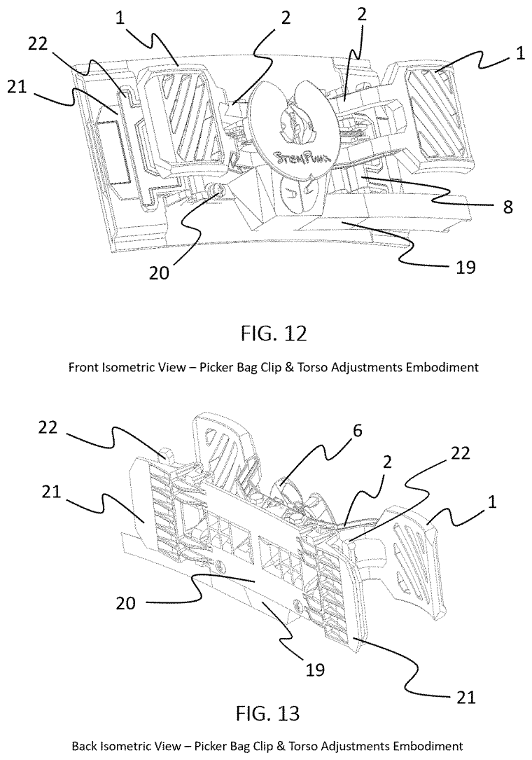

FIG. 12 is an exemplary front isometric view of a hands-free, dual-dexterous clipping device in the embodiment of attaching to a harvest bag straps. The stem collection is formed and defined by a stem exhaust 19 and mounting points to attachment interface brace 20. In this embodiment there is also visibility of the articulating torso support braces 21 and the articulating torso support locks 22, both attached to the base attachment interface brace 8.

FIG. 13 is an exemplary back isometric view of a hands-free, dual-dexterous clipping device in the embodiment of attachment points. In this view, there is increased visibility of the clip formation and all other parts disclosed and detailed in FIG. 12.

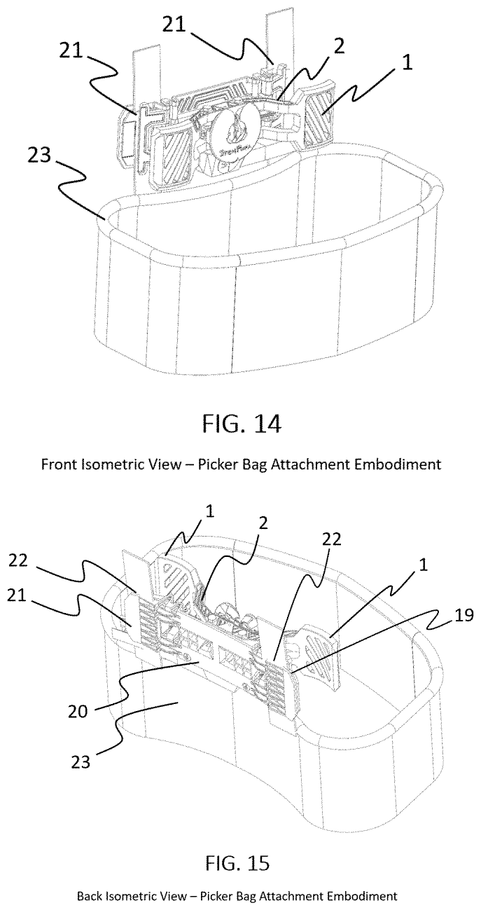

FIG. 14 is an exemplary front isometric view of a hands-free, dual-dexterous stem-clipping device in the embodiment of attachment to a harvest bag straps. In this view, the clip is used to attach the device to a harvest bag 23.

FIG. 15 is an exemplary back isometric view of a hands-free, dual-dexterous stem-clipping device in the embodiment of attachment to a bag clip. In this view, there is increased visibility of the attachment formation from the device to the harvest bag 23.

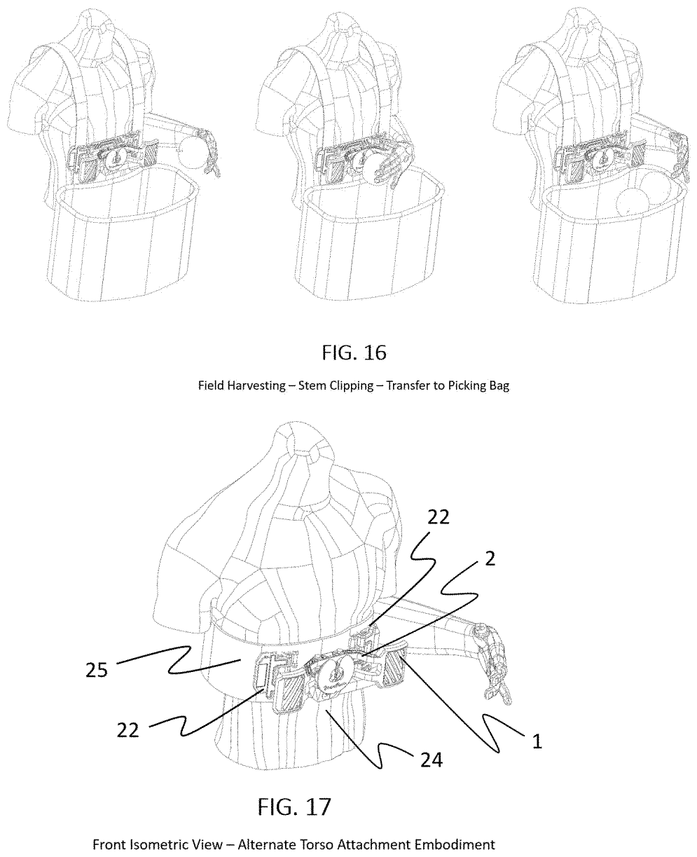

FIG. 16 shows three exemplary views of the clipping device demonstrating the process of cutting stems in the field-harvest environment. The first view, on left, shows the device in the embodiment of attachment to straps on a harvest bag and positioned against a human form. This view illustrates the pre-positioning and targeting of the harvested product in the approach to the stem-clipping device. The second view, in middle, shows the same form again at the stage of engagement with the stem-clipping device; product applied to the product interface brace and safety guide 6, and force applied to the wrist force pads 1 to effectuate cutting of the stem. The third view, on right, shows the same form again illustrating the transfer of the resulting stem-clipped, harvested product to the harvest bag.

FIG. 17 is an exemplary front isometric view of a hands-free, dual-dexterous stem-clipping device in the embodiment of attachment to a human torso 24. In this view, the torso interface brace support 25, is used to attach the device to a torso worn belt or vest.

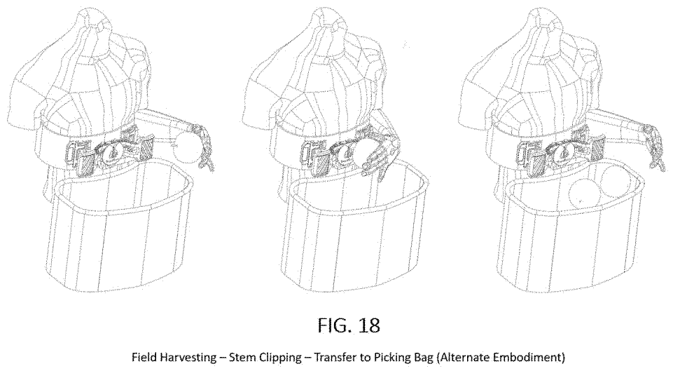

FIG. 18 shows three exemplary views of the clipping device demonstrating the process of cutting stems in the field-harvest environment, using the alternate embodiment of a torso-worn mounting system. The first view, on left, shows the device in the embodiment of attachment above the harvest bag and positioned against a human form. This view illustrates the pre-positioning and targeting of the harvested product in the approach to the stem-clipping device. The second view, in middle, shows the same form again at the stage of engagement with the stem-clipping device; product applied to the product interface brace and safety guide 6, and force applied to the wrist force pads 1 to effectuate cutting of the stem. The third view, on right, shows the same form again illustrating the transfer of the resulting stem-clipped, harvested product to the harvest bag.

The terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A mechanical device used to cut stems on agricultural products which can be actuated and controlled by the forearms and wrists, leaving the harvester's hands free for other tasks:

2. The system of claim 1, wherein the user of the device can initiate cutting independently from the left side or the right side of the body.

3. The system of claim 1, wherein the forces, cutting height, blade profile and target area of stem, are controlled and adjustable, per the mechanism described herein.

4. The system of claim 1, wherein the movement initiated by the user's wrist or forearms, applies a suitable force which is transferred to a sloped surface, controlling both horizontal and vertical geometry of the mechanism's path, which is then transferred to a precise horizontal blade path, resulting in a controlled force, cutting profile and precise blade alignment, for said purposes.

5. The system of claim 1, wherein the blade profile can be modified for a variety of agricultural product harvesting, while keeping the physics of the mechanism and geometry, as described herein.

6. The system of claim 1, wherein the device is connected to a clip and attached to a harvest bag or bulk container as a compliment to the normal harvest process.

7. The system of claim 1, wherein the device is connected to a clip which maintains grip and relative positioning on a harvest bag while allowing for upward swiveling of the bag to adjust to certain factors in the harvest environment, such as the height of bulk harvest containers.

8. The system of claim 1, in an alternate embodiment, wherein the mechanism described is mounted to the torso on a belt, vest, or chest harness versus clipped to a harvesting bag.

9. The system of claim 1, in an alternate embodiment, wherein the forces applied can be substituted by an electromechanical drive motor.

10. The system of claim 1, in an alternate embodiment, wherein the electromechanical drive motor is controlled by a microprocessor and drive circuitry, such that further harvesting, status, and cutting metrics can be collected at the point of harvest, then communicated and analyzed, allowing tracking and safety tracing through the harvesting and logistics data flow of the product being harvested.
